(19) United States
(12) Patent Application Publication
(10) Pub. No.: US 2007/0241188 A1
(43) Pub. Date: Oct. 18, 2007

(54) System and method for automated management of purchase in self-service-type sales point

(76) Inventor: Jerry Liao, Sindian City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/634,180

(22) Filed: Dec. 6, 2006

(30) Foreign Application Priority Data
Apr. 18, 2006 (TW) 95113861

(51) Int. Cl. G06K 7/00

(52) U.S. Cl. 235/383

(57) ABSTRACT

In a system for automated management of purchase in a self-service-type sales point, a system management host, at least one trolley, and a plurality of different products are provided in the sales point. The products are individually provided with a barcode, and the trolley is assigned a specific certification number. The trolley is provided with a trolley terminal having a barcode reader and a scale connected thereto for scanning the barcode on a purchased product and weighing the purchased product positioned in the trolley, so that a barcode data and a weight data are obtained. The system management host includes a merchandise databank for storing the barcode data of all products displayed in the sales point, and a purchase record memory for storing a purchase record generated by a microcontroller in the host each time a purchased product is scanned and positioned in the trolley.

### FIELD OF THE INVENTION

The present invention relates to a system and method for management of purchase, and more particularly to a system and method for automated management of purchase in a self-service-type sales point.

### BACKGROUND OF THE INVENTION

In a traditional shopping environment, a customer picks desired products from shelves in a sales point, and a cashier at a checkout stand checks and sums the prices of the picked products and collects money from the customer. While payment by card has widely replaced the payment by cash, the above-mentioned traditional manner of shopping does not change too much.

The currently very popular large-scale supermarkets and hypermarkets display more products on shelves for sale, enabling a customer to conveniently purchase desired products at one time in one sales point without the need of doing shopping at different sales points. However, the customers purchasing in the large-scale sales points have to queue up at checkout stands, waiting for the cashiers to check and sum the prices of purchased products and collect money from the customers. For customers, it is really time-consuming to queue up for checkout in the large-scale sales points. On the other hand, the large-scale sales points require a large number of employees and have to undertake high costs for training the employees and managing and auditing the operation in the sales points to avoid losses and disputes due to mistakes in price checking and summing and money collection, etc.

Some other types of relatively convenient shopping environments have been developed in the past a few years. U.S. Pat. No. 6,755,322 discloses an automated shopping system that provides a shelf and a transporter, so that products on the shelf may be safely and smoothly, horizontally and vertically dispensed and carried by the transporter to a delivery station. While the automated shopping system disclosed in U.S. Pat. No. 6,755,322 provides a convenient shopping environment, it does not effectively solve the problems encountered by customers shopping in the currently popular big-scale sales points.

As an attempt to break through the problems in the conventional sales points, the online purchase is developed based on the advancements in the network and electronic commerce technologies. For the purpose of online purchase, a purchase system platform is built over the Internet. An online buyer may be easily linked with the Internet via a personal computer to purchase and pay online without the need of going to a physical store displaying the products. There are prior art in connection with the online purchase. For example, U.S. Pat. No. 6,735,778 discloses a system for providing home shopping programs to viewers, so that buyers may purchase desired products at home through the Internet.

While it provides great conveniences to consumers, the online purchase does not provide so much pleasure as doing shopping in real sales points. Moreover, not all the consumers know a lot about the procedures in online purchase to avoid unexpected risks in online purchase. There is also the problem of network security in terms of payment over network.

### SUMMARY OF THE INVENTION

It is therefore a primary object of the present invention to provide a system for management of purchase in a sales point, so as to provide customers with a shopping environment in which purchase may be more conveniently completed.

Another object of the present invention is to provide a system and method for automated management of purchase in a sales point, in which purchase by a customer is managed through verifying barcode and weight of each product purchased by the customer.

A further object of the present invention is to provide a system for management of purchase, in which barcoded products purchased by a customer are recognized by microcontrollers provided on a system management host and each product-carrying trolley to enable real-time transmission of purchase-related information in the system.

A still further object of the present invention is to provide a system and method for automated management of purchase in sales point, in which barcode and weight of a product are used to verify whether a product has been purchased by a customer in correct procedures. In a sales point using this system and method to manage purchase therein, trolleys equipped with a trolley terminal, a barcode reader, and a scale are provided. The barcode on a purchased product has to be scanned by the barcode reader before the purchased product is positioned in the trolley by the customer and automatically weighed, so that barcode and weight data of the purchased product are obtained and compared with barcode and weight data for the same product stored in a system management host. When the obtained barcode and weight data are determined as correct from the comparison result, a purchase record is automatically generated.

As compared with the prior art, the present invention effectively overcomes the problems frequently encountered in many self-service-type sales points, particularly the large-scale supermarkets and hypermarkets, such as a large number of customers queued up for checkout, high labor cost, high cost for employee training on long-term basis, and cost of management and auditing. With the management system and method of the present invention, any product having been purchased may be verified in real time. Moreover, the system and method of the present invention uses product barcode and weight to verify that a product has been purchased by a customer via correct procedures, making it highly valuable when being applied in the commercial field.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is a conceptual view of a system configuration for automated management of purchase in self-service-type sales point according to the present invention;

FIG. 2 is a block diagram of a trolley terminal provided on each trolley used in the system of the present invention;

FIG. 3 is a block diagram of a system management host for the system of the present invention; and

FIG. 4 is a flowchart showing the steps included in a method for automated management of purchase in self-service-type sales point according to the present invention.

### DETAILED DESCRIPTION OF THE PREFERRED EMBODIMENTS

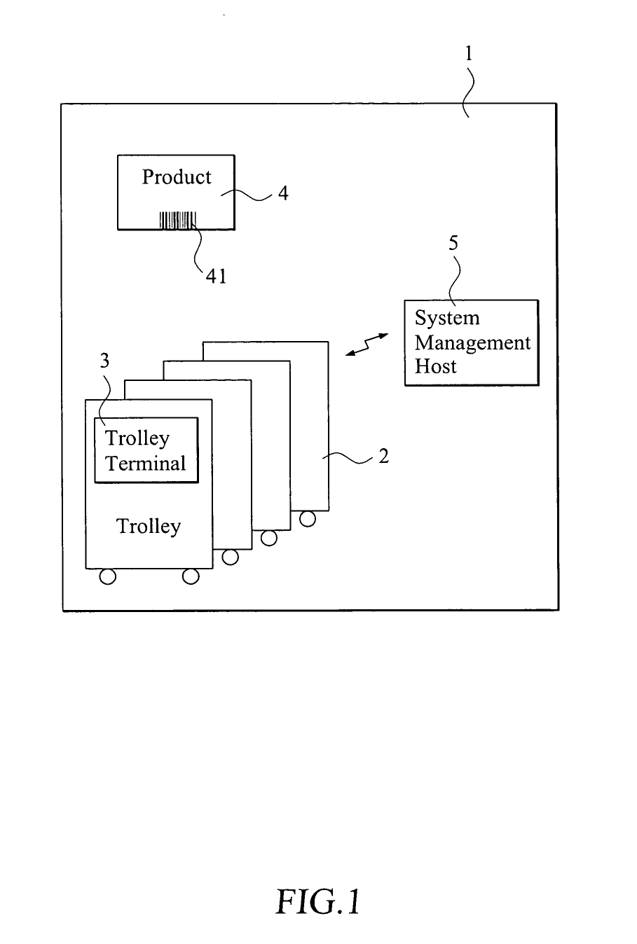

Please refer to FIG. 1 that is a conceptual view of a system configuration for automated management of purchase in self-service-type sales point according to the present invention. As shown, the system of the present invention includes a sales point 1, particularly a self-service-type sales point, a plurality of trolleys 2, i.e., shopping carts, provided for use in the sales point 1, a trolley terminal 3 provided on each of the trolleys 2, a plurality of different products 4 displayed in the sales point for sale, and a system management host 5.

The trolley terminal 3 has the wireless signal transmission function. Each of the products 4 has a corresponding bar code 41 provided thereon. The system management host 5 is located at a predetermined position in the sales point 1, and has the wireless signal receiving function to receive signals transmitted from any of the trolley terminals 3.

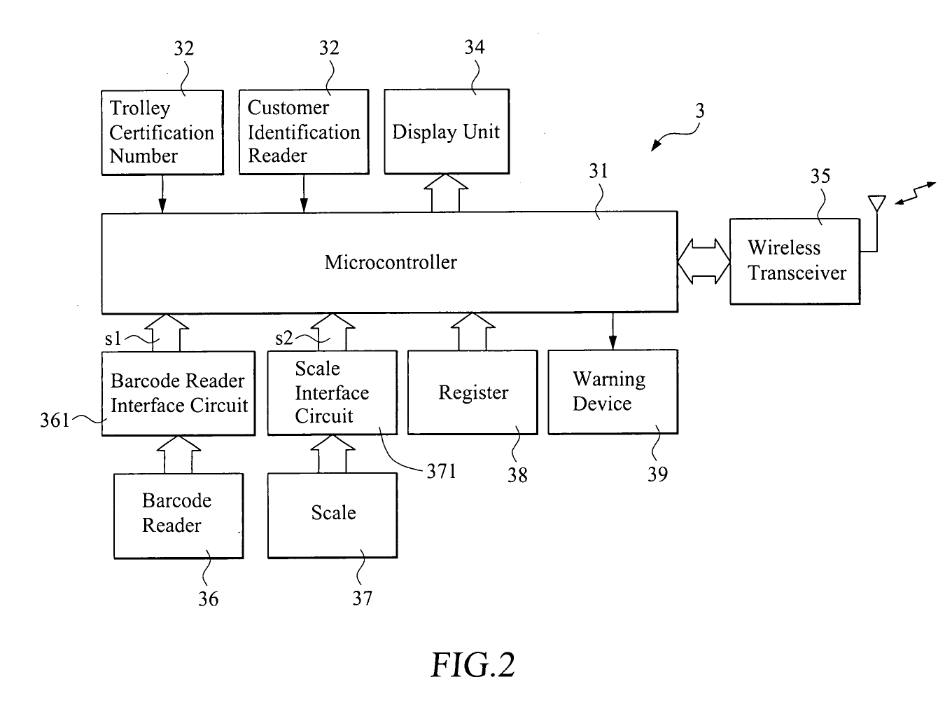

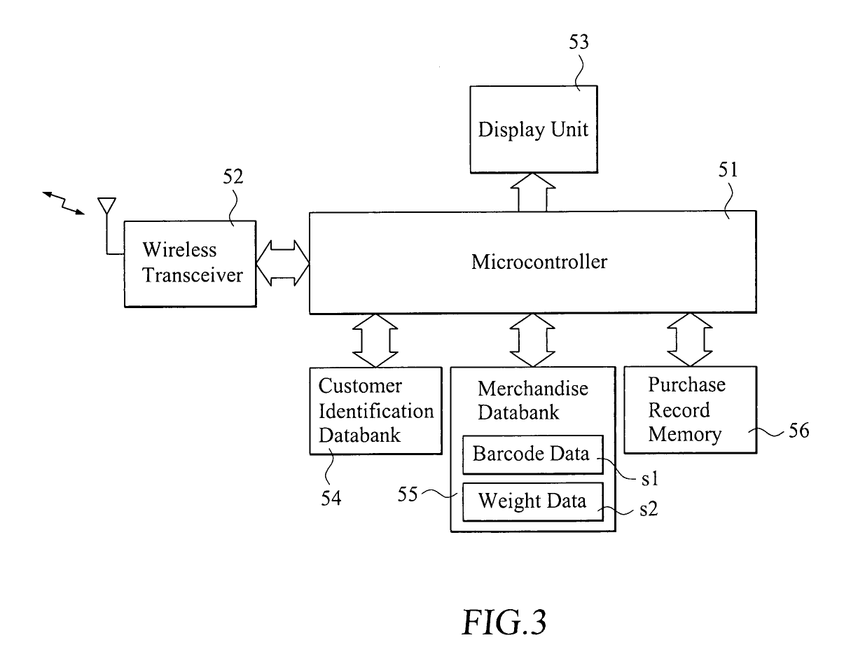

FIGS. 2 and 3 are block diagrams of the trolley terminal 3 and the system management host 3, respectively. Please refer to FIGS. 1, 2, and 3 at the same time. Each of the trolley terminals 3 mounted on the trolleys 2 includes a microcontroller 31, to which a trolley certification number storage unit 32, a customer identification reader 33, a display unit 34, a wireless transceiver 35, a barcode reader 36, a scale 37, a register 38, and a warning device 39 are connected.

Each of the trolleys 2 is assigned a specific certification number, which is stored in the trolley certification number storage unit 32 on the trolley 2 for recognition of the trolley 2. When a customer enters the sales point 1, a credit card or a customer card issued to the customer by the sales point 1 is read by the customer identification reader 33, so that the customer's identification data is input to the microcontroller 31 via the customer identification reader 33 for recognition.

When the microcontroller 31 receives the customer's identification data input by the customer identification reader 33, the customer's personal information is shown on the display unit 34 and simultaneously wirelessly transmitted to the system management host 5 by the wireless transceiver 35, so that the system management host 5 receives and verifies the customer's identification data.

The barcode reader 36 is connected to the microcontroller 31 via a barcode reader interface circuit 361, and is adapted to scan the barcode 41 provided on each product 4 purchased by a customer. The scale 37 is connected to the microcontroller 31 via a scale interface circuit 371, and is adapted to measure the weight of each product 4 purchased by a customer and positioned in the trolley 2.

The register 38 temporarily stores information about the customer identification data, the barcodes and the weights of products 4 having been purchased, etc. The warning device 39 is able to timely emit warning sound or light when an incorrect condition in purchase occurs.

The system management host 5 includes microcontroller 51, to which a wireless transceiver 52, a display unit 53, a customer identification databank 54, a merchandise databank 55, and a purchase record memory 56 are connected. The wireless transceiver 52 is adapted to receive wireless signals transmitted by the wireless transceivers 35 at the trolley terminals 3. A plurality of customer identification data is stored in the customer identification databank 54. Barcode data s1 and weight data s2 of all products 4 displayed in the sales point 1 are recorded and stored in the merchandise databank 55 in advance. And, the purchase record memory 56 stores multiple purchase records R1, R2, R3 when the products 4 are purchased by customers in a normal way.

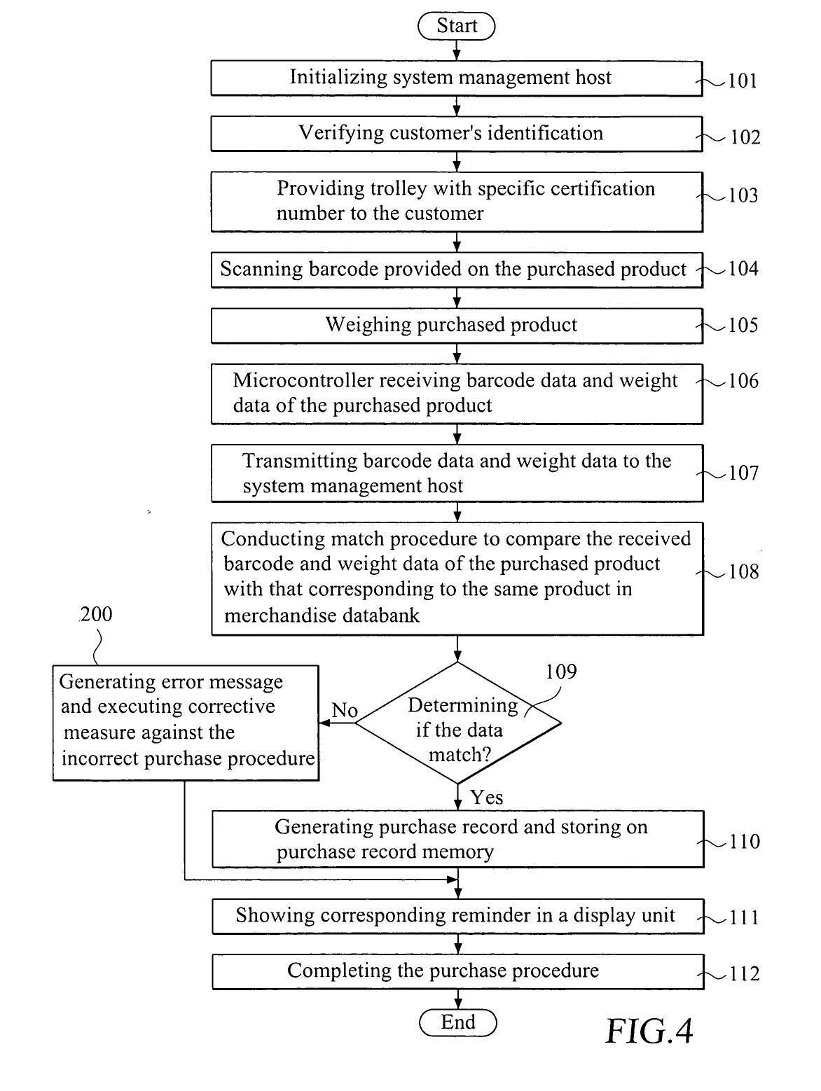

Please refer to FIG. 4 that is a flowchart showing the steps included in a method for automated management of purchase in self-service-type sales point according to the present invention. First, a system management host 5 is initialized and starts receiving and managing the purchase condition of every customer in the sales point 1 (step 101). When a customer enters the sales point 1, the customer's identification is verified (step 102), and a trolley 2 having a certification number assigned thereto is provided to the customer (step 103). Then, the customer may start purchasing products 4 in the sales point 1.

When the customer picks up a desired product 4 from a shelf, the product 4 is scanned by a barcode reader 36 on the trolley 2, so that a barcode 41 provided on the product 4 is read (step 104), and a barcode data s1 of the product 4 is sent to a microcontroller 31 of a trolley terminal 3 provided on the trolley 2. Then, the customer may position the picked product 4 at a holding position in the trolley 2, and the product 4 is weighed by a scale 37 mounted in the trolley 2 below the holding position, so that the weight of the product 4 is determined (step 105), and a weight data s2 of the product 4 is sent to the microcontroller 31. The microcontroller 31 receives the barcode data s1 and the weight data s2 (step 106), and the received data s1, s2 are transmitted by the microcontroller 31 in real time via a wireless transceiver 35 built on the trolley 2 to the system management host 5 (step 107).

When the system management host 5 has received the barcode data s1 and the weight data s2 of the product 4 transmitted from the trolley terminal 3, a match procedure is conducted to compare the received data s1, s2 with barcode data s1 and weight data s2 of the product 4 stored in a merchandise databank 55 built in the system management host 5 (step 108). Then, it is determined whether the received data s1, s2 match the data s1, s2 stored in the merchandise databank 55 (step 109). If it is determined the received data s1, s2 match the stored data s1, s2, the system management host 5 generates a purchase record R1 indicating the product 4 has been purchased in correct procedures, and the purchase record R1 is stored on a purchase record memory 56 (step 110). Each purchase record R1 includes information about the description, the price, and/or the quantity of the purchased product 4. Meanwhile, a corresponding reminder about the purchase is also shown in a display unit 34 on the trolley terminal 3 (step 111). At this point, the customer has correctly completed the purchase procedures (step 112).

In the event it is determined in the step 109 that the received s1, s2 do not match the stored data s1, s2, an error message is generated and a corrective measure against the incorrect purchase procedure is executed (step 200). For example, when a picked product 4 is positioned in the trolley 2 without being scanned by the barcode reader 36, the scale 37 would detect an increase of weight in the trolley 2, and the wireless transceiver 35 of the trolley terminal 3 would transmit a corresponding signal to the system management host 5. When the system management host 5 receives the signal indicating the weight of a purchased product 4 without receiving any signal indicating the barcode of the same product 4, it is detected that the purchased product 4 is not scanned by the barcode reader 36 before being positioned in the trolley 2. At this point, an error message is transmitted from the system management host 5 via a wireless transceiver 52 thereof to the trolley terminal 3, and a warning message is immediately shown in the display unit 34 on the trolley terminal 3 to remind the customer of the non-scanned product 4, and the warning message would continue until the customer removes the non-scanned product 4 from the trolley 2.

Or, when the customer removes a product 4 from the trolley 2 after the correct purchase procedures have been completed for that product 4, a decrease of weight in the trolley is detected, and the trolley terminal 3 and the system management host 5 would control the display unit 34 to guide the customer to cancel the corresponding purchase record R1. To cancel the purchase record R1, simply scan the barcode 41 of the product 4 to be returned again using the barcode reader 36. And, the correct purchase may be continued.

What is claimed is:

1. A system for automated management of purchase in self-service-type sales point, comprising:
a self-service-type sales point, in which a plurality of different products for sale are displayed, each of the products being provided with a corresponding barcode thereon;
at least one trolley being movable by a customer in the sales point for holding products purchased by the customer;
a trolley terminal provided on the at least one trolley, and including:
a first microcontroller;
a barcode reader for scanning the barcode on each of the products purchased by the customer and generating a corresponding barcode data; and
a first wireless transceiver adapted to transmit the barcode data corresponding to each of the purchased products; and
a system management host located at a predetermined position in the sales point, and including:
a second microcontroller;
a merchandise databank, in which barcode data corresponding to all products displayed in the sales point are stored in advance;
a second wireless transceiver adapted to receive the barcode data transmitted by the first wireless transceiver of the trolley terminal provided on the at least one trolley; and
a purchase record memory for storing a purchase record generated by the second microcontroller each time a purchased product is positioned in the trolley.

2. The system for automated management of purchase in self-service-type sales point as claimed in claim 1, wherein the trolley terminal further includes a trolley certification number storage unit, in which a specific trolley certification number assigned to the at least one trolley is stored.

3. The system for automated management of purchase in self-service-type sales point as claimed in claim 1, wherein the trolley terminal further includes a customer identification reader for recognizing a customer's identification.

4. The system for automated management of purchase in self-service-type sales point as claimed in claim 1, wherein the trolley terminal further includes a display unit.

5. The system for automated management of purchase in self-service-type sales point as claimed in claim 1, wherein the trolley terminal further includes a scale, which is connected to the first microcontroller via a scale interface circuit for measuring the weight of a product purchased by the customer.

6. The system for automated management of purchase in self-service-type sales point as claimed in claim 1, wherein the trolley terminal further includes a warning device adapted to timely emit a warning when an incorrect condition in purchase occurs.

7. The system for automated management of purchase in self-service-type sales point as claimed in claim 1, wherein the system management host further includes a customer identification databank for storing a plurality of customer identification data therein.

8. The system for automated management of purchase in self-service-type sales point as claimed in claim 1, wherein the merchandise databank further stores weight data corresponding to all products displayed in the sales point.

9. A method for automated management of purchase in self-service-type sales point, the self-service-type sales point being provided with a system management host and at least one trolley, and having a plurality of different products displayed therein for sale, each of the products being provided with a corresponding barcode, and the at least one trolley being movable by a customer in the sales point for holding products purchased by the customer; the method comprising the steps of:
(a) reading and recognizing the customer's identification;
(b) assigning the at least one trolley to the customer;
(c) scanning the barcode on each product purchased by the customer to obtain a barcode data of the purchased product;
(d) weighing the purchased product to obtain a weight data of the purchased product;
(e) sending the obtained barcode data and weight data to the system management host;
(f) conducting a match procedure at the system management host to compare the barcode data and weight data of the purchased product received by the system management host with barcode data and weight data of the same product stored in a merchandise databank built in the system management host; and
(g) determining whether the received barcode data and weight data match the stored barcode data and weight data; if yes, a purchase record is generated and stored in a purchase record memory in the system management host; and if not, an error message is generated.

10. The method for automated management of purchase in self-service-type sales point as claimed in claim 9, wherein, in the step (e), the barcode data and the weight data of the purchased product are wirelessly transmitted to the system management host.

11. The method for automated management of purchase in self-service-type sales point as claimed in claim 9, further comprising a step of showing a corresponding reminder about the purchase in a display unit on the trolley when the received barcode data and weight data are determined as matching the stored barcode data and weight data in the step (g).

12. The method for automated management of purchase in self-service-type sales point as claimed in claim 9, further comprising a step of generating an error message and executing a corrective measure against an incorrect purchase procedure when the received barcode data and weight data are determined as not matching the stored barcode data and weight data in the step (g).
